(19) United States
(12) Patent Application Publication
(10) Pub. No.: US 2019/0032607 A1
(43) Pub. Date: Jan. 31, 2019

(54) FLAP DEVICE

(71) Applicant: Friedrich Boysen GmbH & Co. KG, Altensteig (DE)

(72) Inventors: Karl Stockinger, Ebhausen (DE); Volker Roller, Simmersfeld (DE)

(21) Appl. No.: 16/042,232

(22) Filed: Jul. 23, 2018

(30) Foreign Application Priority Data
Jul. 31, 2017 (DE) 102017117289.0

(51) Int. Cl. F02M 26/70; F02B 37/18

(52) U.S. Cl. CPC F02M 26/70; F01N 2240/36; F02B 37/183

(57) ABSTRACT

A flap device for controlling a gas flow through a pipe comprises a flap that is rotationally fixedly connected to a flap shaft and at least one support unit by means of which the flap shaft is rotatably supported. A radial hollow space that is bounded in an axial direction by respective attachment surfaces is formed between the flap shaft and a reception section of the support unit. A damping element composed of an elastic material is clamped in the hollow space with axial and/or radial deformation and/or preload.

The present invention relates to a flap device for controlling a gas flow through a pipe, in particular to an exhaust gas flap device for an exhaust train of a motor vehicle, having a flap that is rotationally fixedly connected to a flap shaft and having at least one support unit by means of which the flap shaft is rotatably supported.

Such devices are, for example, used for a selective closing of exhaust gas paths in exhaust gas systems of motor vehicles. An actuating drive is typically provided by means of which the flap can be rotated between a position releasing the exhaust gas flow and a position blocking the exhaust gas flow. A partial or complete blocking of the exhaust gas flow can, for example, take place as part of the acoustic configuration of exhaust gas systems or for a direct generation of a counter-pressure. Exhaust gas flaps can also be used as part of an exhaust gas return system for a nitrogen oxide reduction within the engine, for example to directly apply a specific amount of exhaust gas to a low pressure path at the fresh air side of an internal combustion engine. In principle, flap devices of the initially named kind can also be used in the intake system of an internal combustion engine.

Exhaust gas flaps are exposed to high temperatures, considerable temperature fluctuations, different temperature developments, and mechanical strains during operation. A particular problem is found with loads by vibration that occur due to engine excitation, by roadway excitation, or due to gas pulsation. Since a clearance-free support of exhaust gas flaps and the like is practically not possible with a justifiable effort, there is the problem with conventional flap devices that mechanical disturbing noises occur on a sufficiently pronounced vibration excitation and a matching excitation frequency. These disturbing noises generally result from the reciprocal abutting of the flap at the pipe or at the associated flap housing and of the flat shaft at the support unit. In practice, rattling or ringing noise can occur by this effect that is perceived as disturbing to a high degree.

It is an object of the invention to reduce or to avoid disturbing noises generated by load by vibration in the operation of flap devices.

The invention is satisfied by a flap device having the features of claim 1.

With a flap device in accordance with the invention, a radial hollow space that is bounded in an axial direction by respective attachment surfaces is formed between the flap shaft and a reception section of the support unit. In accordance with the invention, a damping element composed of an elastic material is clamped in the hollow space with axial and/or radial deformation and/or preload. A hollow space present in the support region is therefore used to accommodate a damping element under mechanical strain. The movement of the combination of flap and flap shaft is damped by the elastic damping element (in particular in the radial direction) so that a building up of vibrations up to the disruptive frequency is counteracted and disturbing noises are avoided. The damping is particularly effective since it takes place directly in the region of the support. A flap device in accordance with the invention therefore also generates hardly any or no disturbing noises with strong gas pulsations.

The terms “axial” and “radial” are to be understood with respect to the intended axis of rotation of the flap shaft within the framework of the present disclosure.

With a flap device in accordance with the invention, a radial preload of the damping element can be caused by a deformation that is ultimately due to an axial preload. It is not necessary with such an embodiment to actively radially preload the damping element that is to act on it radially. It is, however, generally possible to provide an active radial preload.

The damping element is preferably partly or completely produced from a wire mesh or from a fiber material. Such materials have a sufficient elasticity and simultaneously a high temperature resistance. The damping elements can in particular be designed as a wire mesh compact. The damping element can furthermore comprise a wire mesh mat and/or a silicate fiber material.

An embodiment of the invention provides that the flap shaft is fixed, preferably with clearance, radially in the reception section by means of at least one support element separate from the damping element. It is therefore preferred that the flap shaft is not supported by means of the damping element. The damping element rather preferably serves only for the damping of the movement of the flap shaft within the clearance. The support element can provide a plain bearing support for the flap shaft and is preferably of ring shape. The flap shaft can be supported with an axial clearance and/or with a radial clearance. A sufficient movability of the flap is ensured in all operating points by the clearance.

The damping element is preferably arranged in the hollow space at a side of the support element remote from the flap and axially offset from sad support element. This facilitates the manufacture of the flap device to the extent that the damping element can be inserted into the hollow space from outside with an already present rotational support and can optionally be acted on by a termination element.

A step by which the support element is fixed in the axial direction, in particular in an axial direction facing away from the flap, can be formed at an inner wall of the hollow space. Such a step forms an axial abutment for the support element and also holds it at the support unit with a hollow space open at one side. The damping element can be inserted into the hollow space through the corresponding opening during manufacture without there being any risk of an unintended release of the support element. To further simplify the design, the damping element can, however, also be arranged in the hollow space directly adjacent to the support element.

The support element can be directly or indirectly supported at the pipe. This allows a particularly simple design of the support unit.

In accordance with an embodiment of the invention, the damping element is supported at an inner side of the reception section in a radial direction and is acted on by a separate tensioning part in an axial tensioning direction. Due to the axial action, the elastic material of the damping element is pushed radially inwardly (an escape in the radially outward direction is prevented by a wall of the reception section) so that a radial preload results without any direct radial action. This means that the damping element can be preloaded both axially and radially by a separation tensioning part. The separate tensioning part can be adjustable in the axial direction to enable an adaptation of the level of the preload.

The support unit can have a bearing bushing which is fastened to the pipe and in which the reception section is formed. Such a bearing bushing can be manufactured simply and inexpensively. In general, a correspondingly shaped section of the pipe itself could also form the reception section for the flap shaft.

A further embodiment of the invention provides that a sliding element composed of a friction-reducing material, in particular of graphite or boron nitride, is arranged between the flap shaft and the damping element. A material separation of the flap shaft from the elastic material of the damping element is thereby achieved with a corresponding reduction of the friction load. Instead of a separate sliding element, a coating of a friction reducing material applied to the radial inner side of the damping element could also be provided.

The sliding element can be of ring shape, that is it can be designed as a ring or as a sleeve. Such a sliding element can be manufactured particularly simply and inexpensively.

The sliding element can be slit in the axial direction to enable a compensation of the thermal expansion of the flap shaft and to counteract a jamming. A non-slit shape, that is a closed shape, can also in particular be provided when the sliding element is produced from an elastic material.

The sliding element and the damping element are preferably captively coupled to one another. Such a coupling can, for example, be effected via at least one form fit feature. The sliding element and the damping element can then be handled as a unit.

The damping element can be rectangular in the axial section and/or circular in the radial section.

The invention also relates to a method of manufacturing a flap device, in particular a flap device such as described above, comprising the steps:
providing a support unit and a flap to be rotatably supported that is rotationally fixedly connected to a flap shaft;
introducing the flap shaft into a reception section of the support unit such that a radial hollow space that is bounded in an axial direction by an attachment surface is formed between the flap shaft and the reception section;
inserting a damping element composed of an elastic material into the hollow space;
acting on the inserted damping element by means of a tensioning element at least in an axial tensioning direction facing toward the attachment surface to clamp the damping element in the hollow space with axial and/or radial deformation and/or preload; and
direct or indirect fixing of the tensioning element at the support unit.

The damping element is therefore supported and axially compressed at an attachment. The elastic material of the damping element then attempts to escape in the radial direction, whereby a radial preload also results in addition to the axial preload. It is thus possible in a simple manner to clamp the damping element in the hollow space both axially and radially. The clamped damping element effects a cushioning of movements of the flap shaft that are inter alia caused by gas pulsations. Unwanted disturbing noises, in particular rattling and ringing noises, are prevented in the operation of the flap device in this manner.

The insertion of the optionally provided support element into the hollow space can take place—depending on the manner of construction—before or after the insertion of the damping element.

Further developments of the invention can also be seen from the dependent claims, the description and the enclosed drawings.

The invention will be described in the following by way of example with reference to the drawings.

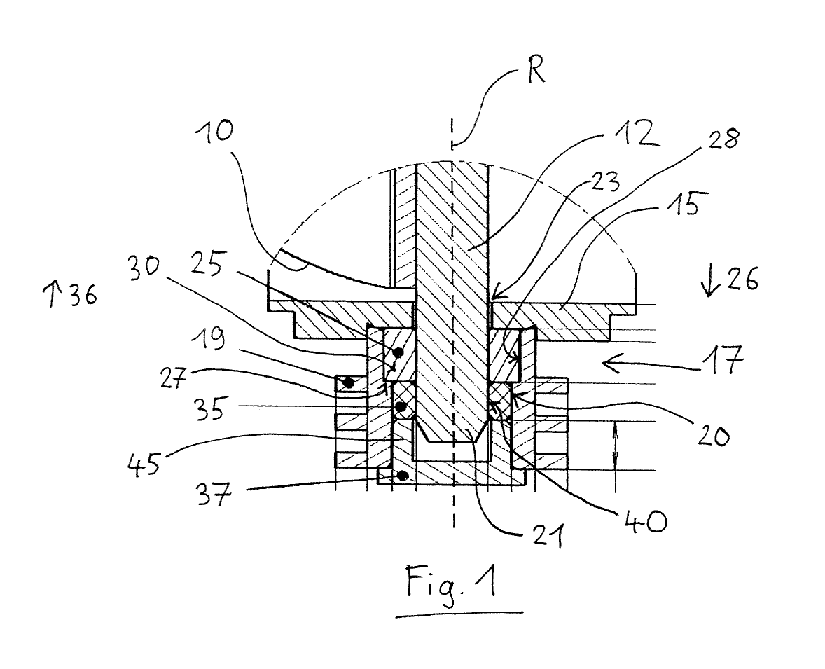

FIG. 1 shows a support unit of a flap device in accordance with the invention in a sectional view;

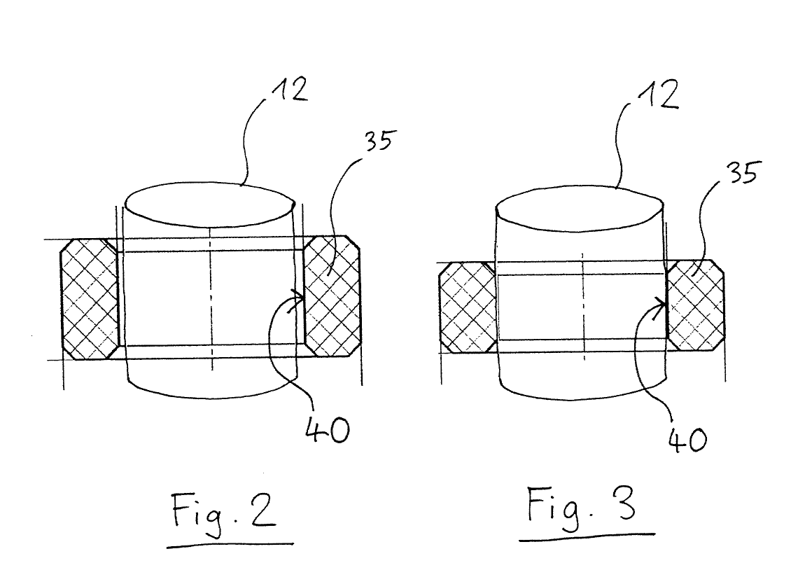

FIG. 2 shows a damping element of the support element shown in FIG. 1 in a non-deformed starting state; and

FIG. 3 shows the damping element in accordance with FIG. 2 in a deformed installed state.

The flap device in accordance with the invention shown in FIG. 1 comprises a plate-like or disk-like flap 10 that is only shown in part and that is attached to a flap shaft 12. The flap 10 is arranged in a pipe 15 and is rotatably supported about an axis of rotation R by means of a support unit 17. The pipe 15 can be the section of an exhaust gas line or a (tubular) flap housing. A gas flow, for example an exhaust gas flow, led through the pipe 15 can be selectively released and (partly) blocked by rotating the flap 10.

The support unit 17 comprises a bearing bushing 19 which is fastened to the pipe 15 and in which a reception section 20 for a shaft stub 21 of the flap shaft 12 is formed. The shaft stub 21 is led through a shaft leadthrough 23 of the pipe 15 and is supported in the bearing bushing 19 with clearance by means of an annular support element 25. The flap 10 can be supported at one side. Alternatively, the flap shaft 12 can have two oppositely disposed shaft stubs 21 and can be supported at both sides by means of respective support units 17. One of the shaft stubs can be connected to a drive device to drive the shaft 12.

As can be recognized in FIG. 1, the support element 25 is directly supported at the pipe 15. In general, the support element 25 could also be supported at the pipe 15 via at least one additional component. In an axial direction 26 facing away from the flap 10, the support element 25 is supported at a step 27 that is provided at an inner wall 28 of a hollow space 30 formed in the bearing bushing 19 radially between the flap shaft 12 and the reception section 20. A damping element 35 composed of an elastic material, preferably of a wire mesh, is furthermore located in the hollow space 30 in the shape of an annular gap.

The damping element 35 is directly supported at the support element 25 in an axial direction 36 facing toward the flap 10. In the opposite axial direction 26, the damping element 35 is supported at a termination element 37 of the support unit 17 fixed to the bearing bushing 19 at the end side. The damping element 35 is therefore clamped between the support element 25, the termination element 37, and the inner wall 28 and is preloaded both axially and radially. The movements of the flap shaft 12 relative to the pipe 15 and to the bearing bushing 19 that occur during the operation of the flap device are damped by the clamped elastic damping element 35 so that unwanted disturbing noises also do not occur with pronounced pressure pulsations in the pipe 15. Both the elasticity of the clamped damping element 35 and the inner friction contribute to the noise-reducing effect. The temperature resistance of the damping element 35 can be adapted in wide ranges by selection of a corresponding material for the wire mesh. The stiffness of the damping element 35 can also be set to a desired value by the material selection.

To reduce the friction between the damping element 35 and the flap shaft 12, a coating, not shown, of a friction-reducing material such as graphite or boron nitride can be provided at a radial inner side 40 of the damping element 35. An embodiment, not shown, of the invention, additionally provides a separate sliding ring composed of a friction-reducing material that is arranged between the damping element 35 and the shaft stub 21. The sliding ring can be slit to be able to compensate thermally induced expansion movements of the shaft stub 21 and/or of the bearing bushing 19. The sliding ring and the damping element 35 can be captively coupled to one another by means of one or more geometrical form-fit features.

The flap 10 is arranged in the pipe 15 and the shaft stub 21 of the flap shaft 12 is led through the shaft leadthrough 23 to manufacture a flap device in accordance with the invention. The support element 25 is placed onto the shaft stub 21 and the bearing bushing 19 is fastened to the pipe 15 to form the support unit 17. The damping element 35 is then introduced into the hollow space 30 in the non-deformed starting state shown in FIG. 2 until it abuts the support element 25. The termination element 37 is subsequently inserted into the hollow space 30. In this respect, the damping element 35 is acted on by a projection 45 of the termination element 37 so that an axial preload takes place. The axial preload is converted by the elastic material of the damping element 35 into a radial preload so that the damping element 35 is also radially clamped in the hollow space 30.

In the installed state shown in FIG. 3, the damping element 35 is deformed and thus preloaded both in the axial direction and in the radial direction. The fastening of the bearing bushing 19 to the pipe 15 and the fixing of the termination element 37 to the bearing bushing 19 can respectively take place by welding.

The invention enables a low-noise operation of exhaust gas flaps and of similar flap devices even with a strong gas pressure pulsation in the associated pipe 15.

### REFERENCE NUMERAL LIST

10 flap
12 flap shaft
15 pipe
17 support unit
19 bearing sleeve
20 reception section
21 shaft stub
23 shaft leadthrough
25 support element
26 axial direction
27 step
28 inner wall
30 hollow space
35 damping element
36 axial direction
37 termination element
40 inner side
45 projection
R axis of rotation

1. A flap device for controlling a gas flow through a pipe, the flap device comprising:
a flap that is rotationally fixedly connected to a flap shaft; and
at least one support unit by means of which the flap shaft is rotatably supported,
wherein a radial hollow space that is bounded in an axial direction by respective attachment surfaces is formed between the flap shaft and a reception section of the support unit;
and wherein a damping element composed of an elastic material is clamped in the hollow space with axial and/or radial deformation and/or preload.

2. The flap device in accordance with claim 1,
that is an exhaust gas flap device for an exhaust train of a motor vehicle.

3. The flap device in accordance with claim 1,
wherein the damping element is partly or completely produced from a wire mesh or from a fiber material.

4. The flap device in accordance with claim 1,
wherein the flap shaft is radially fixed in the reception section by means of at least one support element separate from the damping element.

5. The flap device in accordance with claim 4,
wherein the flap shaft is radially fixed with clearance in the reception section.

6. The flap device in accordance with claim 4,
wherein the damping element is arranged at a side of the support element remote from the flap axially offset from said support element in the hollow space.

7. The flap device in accordance with claim 4,
wherein a step by which the support element is fixed in the axial direction is formed at an inner wall of the hollow space.

8. The flap device in accordance with claim 7,
wherein the step by which the support element is fixed in the axial direction is formed in an axial direction facing away from the flap.

9. The flap device in accordance with claim 4,
wherein the support element is directly or indirectly supported at the pipe.

10. The flap device in accordance with claim 1,
wherein the damping element is supported in a radial direction at an inner side of the reception section and is acted on by a separate tensioning part in an axial tensioning direction.

11. The flap device in accordance with claim 1,
wherein the support unit has a bearing bushing which is fastened to the pipe and in which the reception section is formed.

12. The flap device in accordance with claim 1,
wherein a sliding element composed of a friction-reducing material is arranged between the flap shaft and the damping element.

13. The flap device in accordance with claim 12,
wherein the friction-reducing material is one of graphite and boron nitride.

14. The flap device in accordance with claim 12,
characterized in that
the sliding element is ring shaped.

15. The flap device in accordance with claim 14,
wherein the sliding element is slit in the axial direction.

16. The flap device in accordance with claim 14,
wherein the sliding element and the damping element are captively coupled to one another.

17. The flap device in accordance with claim 1,
wherein the damping element is rectangular in the axial section and/or circular in the radial section.

18. A method of manufacturing a flap device, the method comprising the steps of:
providing a support unit and a flap to be rotatably supported that is rotationally fixedly connected to a flap shaft;
introducing the flap shaft into a reception section of the support unit such that a radial hollow space that is bounded in an axial direction by an attachment surface is formed between the flap shaft and the reception section;
inserting a damping element composed of an elastic material into the hollow space;
acting on the inserted damping element by means of a tensioning element at least in an axial tensioning direction facing toward the attachment surface to clamp the damping element in the hollow space with axial and/or radial deformation and/or preload; and
direct or indirect fixing of the tensioning element at the support unit.
